(19) United States
(12) Patent Application Publication
(10) Pub. No.: US 2011/0133820 A1
(43) Pub. Date: Jun. 9, 2011

(54) Multi-Stage Charge Pump with Variable Number of Boosting Stages

(76) Inventor: Feng Pan, Fremont, CA (US)

(21) Appl. No.: 12/634,385

(22) Filed: Dec. 9, 2009

(51) Int. Cl. G05F 1/10

(52) U.S. Cl. 327/536

(57) ABSTRACT

A charge pump circuit for generating an output voltage is described. The charge pump includes multiple output generation stages connected in series, where the number of stages operating in a boosting mode is variable in order to regulate the pump. The number of stages arranged in series stays the same, but the last one or more of the stages can be operated in a filtering mode, with the number of boosting stages being lower as the regulation level goes lower. This improves the power consumption and reduces noise at lower regulated output levels.

### FIELD OF THE INVENTION

This invention pertains generally to the field of charge pumps and more particularly to multi-stage charge pumps where the number of pumping stages is variable.

### BACKGROUND

Charge pumps use a switching process to provide a DC output voltage larger or lower than its DC input voltage. In general, a charge pump will have a capacitor coupled to switches between an input and an output. During one clock half cycle, the charging half cycle, the capacitor couples in parallel to the input so as to charge up to the input voltage. During a second clock cycle, the transfer half cycle, the charged capacitor couples in series with the input voltage so as to provide an output voltage twice the level of the input voltage. This process is illustrated in FIGS. 1a and 1b. In FIG. 1a, the capacitor 5 is arranged in parallel with the input voltage V_{IN} to illustrate the charging half cycle. In FIG. 1b, the charged capacitor 5 is arranged in series with the input voltage to illustrate the transfer half cycle. As seen in FIG. 1b, the positive terminal of the charged capacitor 5 will thus be 2*V_{IN} with respect to ground.

Charge pumps are used in many contexts. For example, they are used as peripheral circuits on flash and other non-volatile memories to generate many of the needed operating voltages, such as programming or erase voltages, from a lower power supply voltage. A number of charge pump designs, such as conventional Dickson-type pumps, are know in the art. But given the common reliance upon charge pumps, there is an on going need for improvements in pump design, particularly with respect to trying to reduce the amount of layout area and the efficiency of pumps.

### SUMMARY OF THE INVENTION

A charge pump system for generating an output voltage is presented. In a first set of aspects, the system includes a multi-stage charge pump (N total stages), where each stage receives one of a plurality of clock signals and the stages connected in series, with an input of the first stage in the series connected to receive an input voltage, an output of each of the stages except the last in the series connected to provide an input for the next stage, and an output of the last in the series provides the output voltage. The system also includes regulation circuitry connected to receive a reference voltage and the output voltage and derive from these a control signal. The system further includes clock circuitry connected to receive the control signal and to provide the plurality of clock signals to the pump stages. In response to the control signal, the charge pump system operates in one of a plurality modes, including: a first mode, where all of stages receive non-trivial clock signals; and a second mode, where one or more of the stages (L of the total N stages, for L<N), of the series have their clock signals set to ground and the other stages of the series receive non-trivial clock signals.

In a further set of aspects, a charge pump system includes a multi-stage charge pump (N total stages) that are connected in series to receive an input voltage at the first stage and to generate from this an output voltage that is provided from the last stage. The one or more of the stages (M of the N total stages, where M<N) are operable in either of a boosting mode or a filtering mode, and where, in response to a control signal, L of these M (0≦L≦M) stages are operated in the filtering mode and the rest of the stages are operated in the boosting mode. The system also includes regulation circuitry connected to receive the output voltage and a reference voltage and determine from these the control signal.

Additional aspects relate to a method of operating a multi-stage charge pump (N total stages) having an input and an output. The method includes: receiving an input voltage at the input of the charge pump; generating in the charge pump an output voltage from the input voltage; receiving the output voltage at a regulator circuit; receiving a reference level at the regulator circuit; generating, by the regulator circuit, of a control signal based on the output voltage and the reference level; and in response to the control signal, operating the one or more stages as filtering stages and the rest of the stages are boosting stages. The number of stages operated as filtering stages is a non-negative integer less than N whose value is determined based on the value of the control signal.

Various aspects, advantages, features and embodiments of the present invention are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

### BRIEF DESCRIPTION OF THE DRAWINGS

The various aspects and features of the present invention may be better understood by examining the following figures, in which:

FIG. 1a is a simplified circuit diagram of the charging half cycle in a generic charge pump.

FIG. 1b is a simplified circuit diagram of the transfer half cycle in a generic charge pump.

FIG. 2 is a top-level block diagram for a regulated charge pump.

FIGS. 3A and 3B show a 2 stage, 2 branch version of a conventional Dickson type charge pump and corresponding clock signals.

FIGS. 4A and 4B show an exemplary embodiment based on a voltage doubler-type of charge pump.

FIG. 5 shows a comparison of the output I-V curve for the exemplary embodiment versus a conventional pump design.

FIG. 6 shows a comparison of the output (Iout/Iin) versus Vout curve for the exemplary embodiment versus a conventional pump design.

FIG. 7 shows a comparison of the output (Iout/area) versus Vout curve for the exemplary embodiment versus a conventional pump design.

FIGS. 8A-8C illustrates some aspects of a branch of a 4-stage Dickson-type pump and its regulation.

FIG. 9 is an exemplary embodiment of a self-adaptive charge pump.

FIG. 10 illustrates a variable stage charge pump where some of the initial stages are bypassed when not being used.

FIGS. 11A-C schematically illustrate a four stage exemplary embodiment.

FIG. 12 show a more general embodiment.

### DETAILED DESCRIPTION

The techniques presented here are widely applicable to various charge pump designs for the use of cancelling the threshold voltages of the switches (typically implemented as diodes in the prior art) used to prevent the backflow of charge after pump stages. In the following, the description will primarily be based on an exemplary embodiment using a voltage doubler-type of circuit, but the concepts can also be applied to other pump designs.

More information on prior art charge pumps, such as Dickson type pumps, and charge pumps generally, can be found, for example, in “Charge Pump Circuit Design” by Pan and Samaddar, McGraw-Hill, 2006, or “Charge Pumps: An Overview”, Pylarinos and Rogers, Department of Electrical and Computer Engineering University of Toronto, available on the webpage “www.eecg.toronto.edu/˜kphang/ece1371/chargepumps.pdf”. Further information on various other charge pump aspects and designs can be found in U.S. Pat. Nos. 5,436,587; 6,370,075; 6,556,465; 6,760,262; 6,922,096; 7,030,683; 7,554,311; 7,368,979; and 7,135,910; US Patent Publication numbers 2009-0153230-A1; 2009-0153232-A1; and 2009-0058506-A1; and application Ser. Nos. 11/295,906 filed on Dec. 6, 2005; 11/303,387 filed on Dec. 16, 2005; 11/845,939, filed Aug. 28, 2007; 12/144,808 filed on Jun. 24, 2008; 12/135,948 filed Jun. 9, 2008; 12/146,243 filed Jun. 25, 2008; 12/337,050 filed Dec. 17, 2008; 12/506,998 filed on Jul. 21, 2009; and 12/570,646 filed on Sep. 30, 2009. Examples of a pump system with a variable number of branches can be found, for example, in U.S. Pat. No. 5,781,473 and with a variable number of stages can be found, for example, in U.S. Pat. No. 6,370,075.

FIG. 2 is a top-level block diagram of a typical charge pump arrangement. The designs described here differ from the prior art in details of how the pump section 201. As shown in FIG. 2, the pump 201 has as inputs a clock signal and a voltage Vreg and provides an output Vout. The high (Vdd) and low (ground) connections are not explicitly shown. The voltage Vreg is provided by the regulator 203, which has as inputs a reference voltage Vref from an external voltage source and the output voltage Vout. The regulator block 203 regulates the value of Vreg such that the desired value of Vout can be obtained. The pump section 201 will typically have cross-coupled elements, such at described below for the exemplary embodiments. (A charge pump is typically taken to refer to both the pump portion 201 and the regulator 203, when a regulator is included, although in some usages “charge pump” refers to just the pump section 201.)

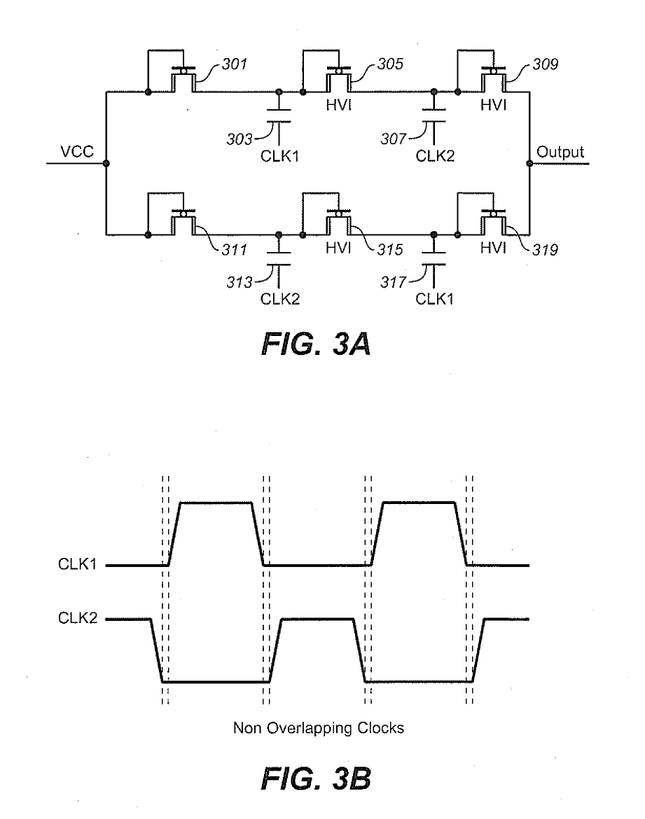

FIG. 3A shows a 2 stage, 2 branch version of a conventional Dickson type charge pump that receives Vcc as its input voltage on the left and generates from it an output voltage on the right. The top branch has a pair of capacitors 303 and 307 with top plates connected along the branch and bottom plates respectively connected to the non-overlapping clock signals CLK1 and CLK2, such as those shown in FIG. 3B. The capacitors 303 and 307 are connected between the series of transistors 301, 305, and 309, which are all diode connected to keep the charge from flowing back to the left. The bottom branch is constructed of transistors 311, 315, and 319 and capacitors 313 and 317 arranged in the same manner as the top branch, but with the clocks reversed so the tow branches will alternately drive the output.

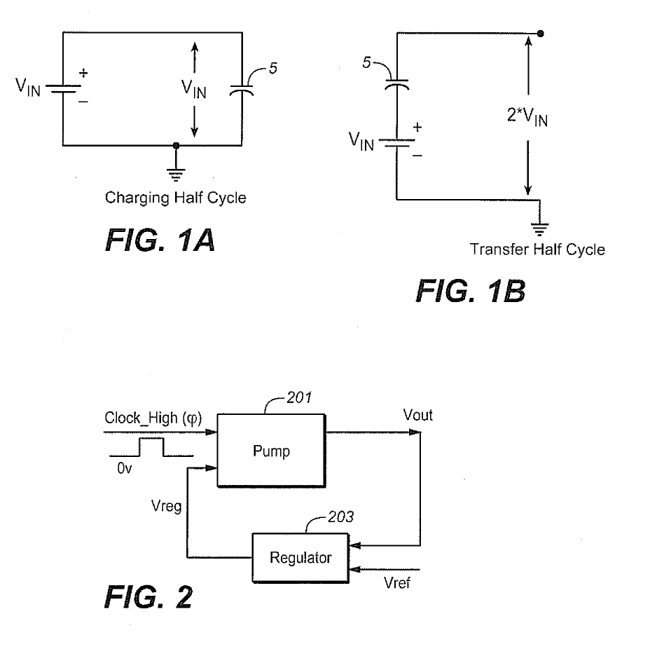

Although the transistors in FIG. 3A are connected to function as diodes, they are not ideal diodes, in the sense that there will be a voltage drop across each of transistors. Between the drain and source of each of these transistors will be a voltage drop. This voltage drop will be the threshold voltage, Vt, of the transistor when there is no current flowing and Vt+ΔVds when there is current, where extra drain-source voltage drop can become proportionately quite large as current increases. Consequently, these voltage drops will reduce the output voltage of a real charge pump below that of the idealized charge pump like that discussed above in the Background with respect to FIG. 1.

Various methods are known to overcome this voltage drops. For example, the number of stages in each branch can be increased to just pump the voltage up higher and the later stages can be used to cancel the threshold voltages. Another example could be a four phase Vt cancellation scheme. However, these prior cancellation techniques have limitations of one sort or another. For example, increases in the number of stages results in increases for both the required layout area and power consumption. Further, as each subsequent transistor in the series is subjected to higher voltages, their respective voltage drops become higher and the incremental gain in each stage correspondingly diminishes. In a four phase Vt cancellation scheme, the clock skews used can be difficult to control due to mismatch and routings.

Instead, the techniques presented here cancel the threshold voltage by introducing a threshold voltage cancellation section that has the same structure as the main section of the charge pump that supplies the output. In the main section, rather than use the transistors connected as diodes, the threshold voltage cancellation stage uses the outputs from the section of the main section that it is mirroring to control the transistors. This will be illustrated using an exemplary embodiment based on a voltage doubler type of charge pump, which has been found to particular for use as an efficient low voltage output charge pump, where, in this example, the goal is to generate a target output of 4 volts from an input voltage of 2.5 volts.

More specifically, with an input voltage of Vcc=2.5 volts, to generate a 4 volt output supply able to deliver 2 mA output current, with minimum input current Ice and area requirements and good power efficiency is challenging. Normally, the sort of Dickson pump of FIG. 3 is the basic architecture for a charge pump; however, for these sorts of values, Dickson pumps have relatively large die size, higher Ice consumption and less efficiency. Normal Vt cancellation schemes are difficult to apply to such architectures. As noted above, these are normally implemented with Dickson pump by pumping to higher than 4 volts in order to meet the design requirement and overcome the higher internal impendence.

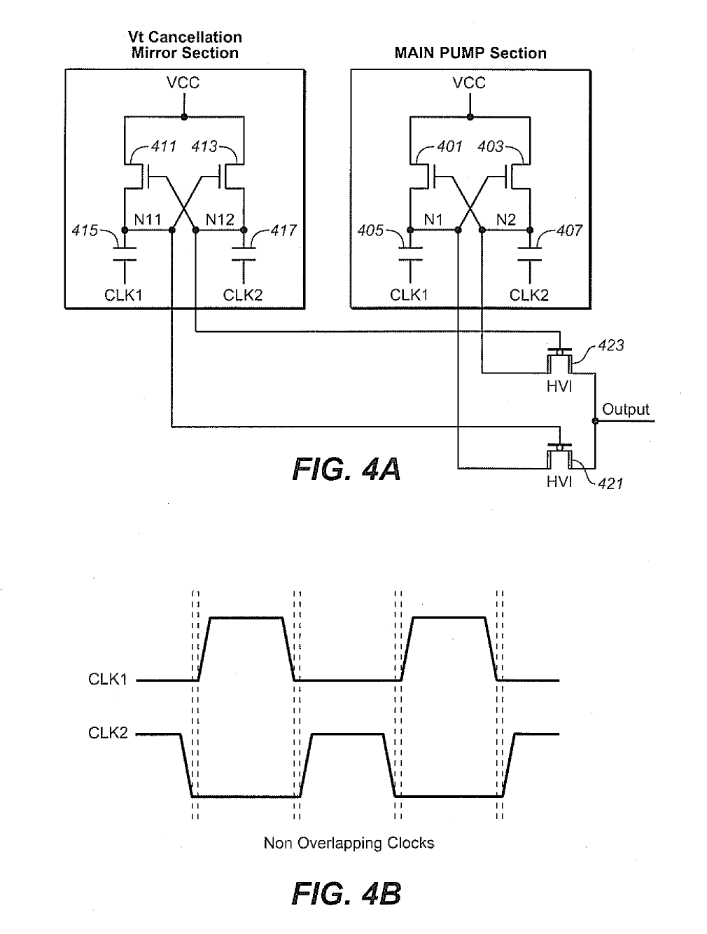

FIG. 4A shows the exemplary embodiment. The main, or output, pump section provides the output to drive the load and has the structure of a voltage doubler. The input voltage Vcc is provided to both branches and through transistor 401 to node N1 in the first branch and through transistor 403 to node N2 in the second branch. The control gates of each of these transistors is then attached to receive the voltage on the other branch, with the gate of 403 to node N1 and the gate of 401 to N2. Each of the nodes is also coupled to a capacitor, respectively capacitor 405 driven by the clock signal CLK1 and capacitor 407 driven by the clock signal CLK2. The clock signals are again non-overlapping clocks such as shown in FIG. 4B. The clock signals can be generated in any of the known manners. As the clocks alternate, the output of each branch will alternately (ideally) provide a doubled output voltage from the nodes N1 and N2, which are then combined to form the pump output.

To prevent the charge from flowing back from the output into the pump, the nodes N1 and N2 are respectively connected to the output through transistors 421 and 423. In a typical prior art arrangement, these two transistors would be connected as diodes, having their control gates connected to also receive the voltages on N1 and N2, respectively. However, this would result in the sort of voltage drops described above. Instead, a threshold voltage cancellation section, as shown on the left side of FIG. 4A is introduced to supply the control gate voltages for these output transistors 421 and 423.

The Vt cancellation section has the same structure and the output section and mirrors its function. A first branch includes transistor 411 and capacitor 415 and a second branch includes transistor 413 and capacitor 417, with the control gates of the transistor in each branch cross-coupled to the output node of the other branch. The output of each branch of the threshold cancellation stage is used to drive the output transistor of the corresponding branch in the output section: the node N11 of the cancellation section is used for the control gate voltage of transistor 421 and the node N22 of the cancellation section is used for the control gate voltage of transistor 423. Since the capacitors in the cancellation section are clocked the same as the same element that they mirror in the output section, when the node N1 of the output section is high, the node N11 in the cancellation section will also be high, so that transistor 421 is on and the output voltage passed; N1 and N11 will similarly be low at the same time, so that 421 is turned off to prevent the back flow of charge. The nodes N2, N22 and transistor 423 function similarly.

Although described here for a pump design based on a voltage doubler, this sort of arrangement for the cancellation of threshold can be used charge pump types. More generally, when used with other designs, in addition to the output section, which will be formed with the same architecture as usual, there will also be a voltage threshold cancellation section formed with the same structure. In the main output section, the transistors typically connected as diodes to charge from back flowing will now have their control gates connected to be set to a voltage from the mirrored node in the voltage cancellation section. For example, going back to FIG. 3A, taking the shown Dickson pump as the output section, a voltage cancellation stage of the same structure (less transistors 309 and 319, which take the role of 421 and 423 in FIG. 4A) would also be included. The level on the equivalent of the top plate of 307 on the cancellation stage would control the gate of 309, the level on the equivalent of the top plate of 303 would control the gate of 305, and so on for the other branch.

It should be noted that although the output section and the cancellation section have the same structure, the various mirrored elements of the circuits need not have the same size since the elements of the output stage need to drive the load of the charge pump, whereas those of the cancellation are only driving some control gates. Returning to the exemplary embodiment, the transistors 401 and 403 and capacitors 405 and 407 need provide sufficient output for the application (e.g., 4 volts and 2 mA). In contrast, the transistors 411 and 413 and capacitors 415 and 417 need only provide sufficient output for the control gate voltage of transistors 421 and 423. For example, if the transistors in the cancellation stages need only be sized a tenth or twentieth that of the elements they mirror in the output stage.

Compared with a typical prior art design based upon a Dickson pump, the exemplary embodiment of FIG. 4A has been found to be of higher efficiency for the target values (output of 2 mA at 4V with an input voltage of 2.5V). More specifically, using a voltage doubler for both the main and the Vt cancellation stage yields about twice the efficiency, with 50% less input current (Ice) consumption. Area efficiency is also improve as the doubler type design can provide these values with less stages, yielding an area efficiency requirement of about 40% that of a conventional Dickson pump.

The scheme presented here also has a number of other advantages. Unlike other Vt cancellation techniques, there is no requirement of the main, output section's stages to cancel the Vts, as the cancellation section handles this. There is also no reliance on complex clock phases or skews since the two pump sections operate in phase with each other. Additionally, the use of identical structures for the two sections results in a better and easier layout matching and clock skew matching of the pump clocks. In particular, the simple design and simple layout requirements are a distinct practical advantage.

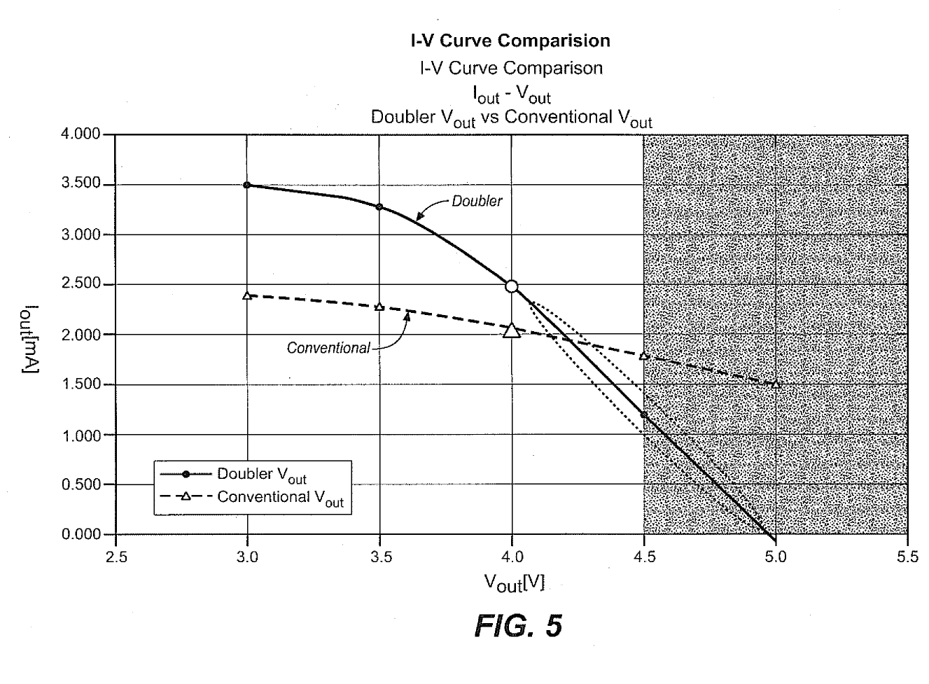

FIGS. 5-7 can help illustrate the efficient of the exemplary embodiment as a low output voltage pump. FIG. 5 shows a comparison of the output I-V curve for the exemplary embodiment versus a conventional pump design. As shown, the doubler can theoretically double the input voltage, here Vcc=2.5, to 5V maximum. The operation region will typically be for voltages of 4.5V or less, as the design is particularly effective between 3V and 4V. For higher outputs from the same input, the design of FIG. 4A can have its number of stages expanded.

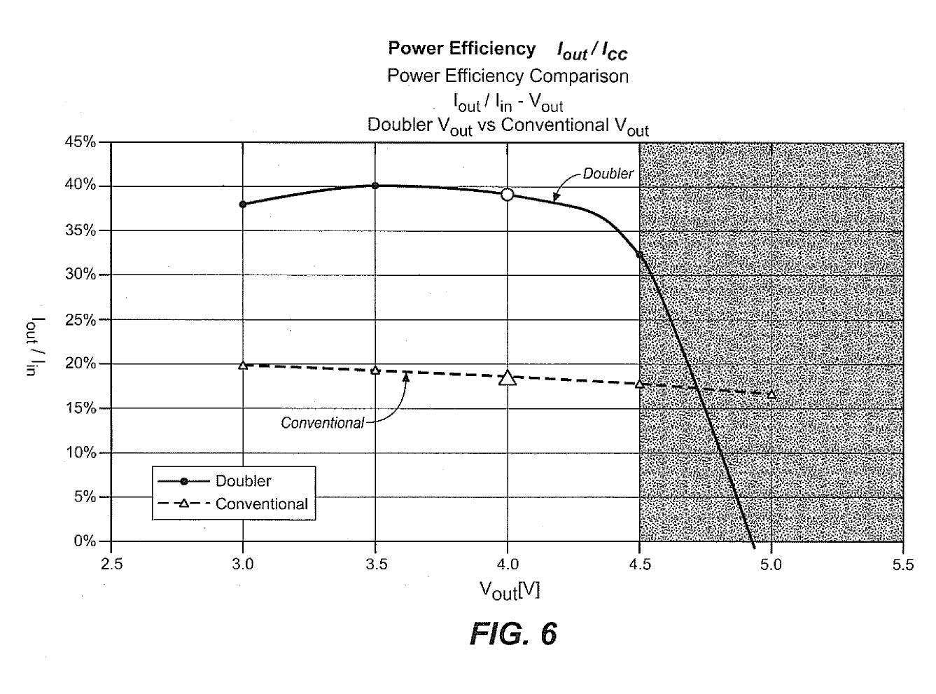

FIG. 6 shows a comparison of the output (Iout/Iin) versus Vout curve for the exemplary embodiment versus a conventional pump design. The power efficiency of the exemplary embodiment is over twice that of a conventional pump at Vout=4V.

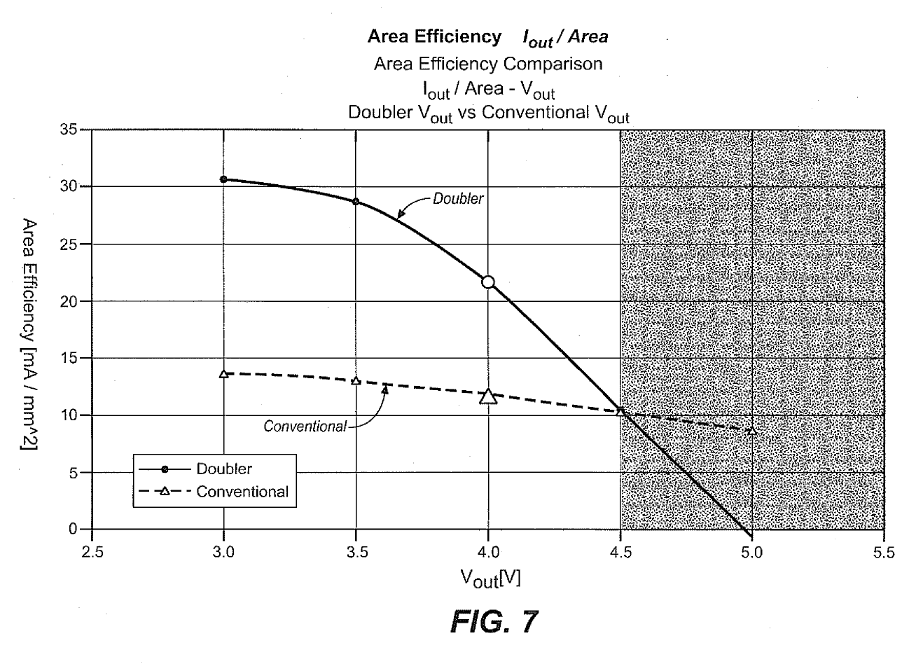

FIG. 7 shows a comparison of the output (Iout/area) versus Vout curve for the exemplary embodiment versus a conventional pump design. The area efficiency of the doubler is about twice that of a conventional pump at Vout=4V, with even better values at lower voltages.

### Self-Adaptive Multi-Stage Implementation

As noted above, for higher outputs the charge pump can have multiple stages. Multi-stage charge pumps and, in the exemplary embodiment, a multi-stage implementation of the sort of design described above with respect to FIGS. 4A and 4B are considered.

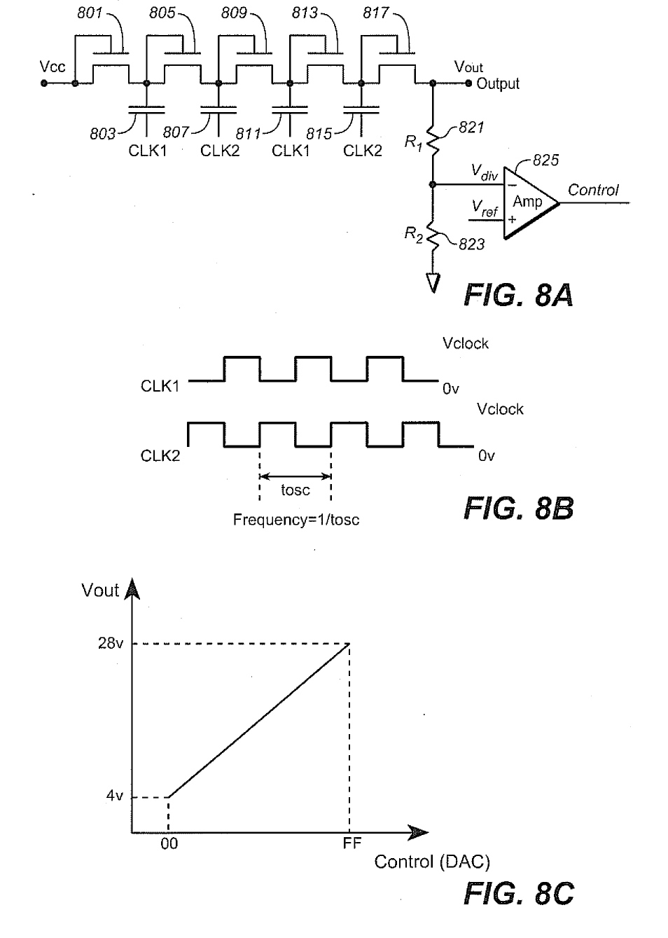

First, the a multi-stage version of the sort of Dickson-type charge discussed above with respect to FIG. 3A is looked at some more to provide some context. FIG. 8A shows a branch of a four stage Dickson-type charge pump and some of the regulation circuitry. A series of diodes 801, 805, 809, 813 and 817, here implemented as diode connected transistors are connected in series with a capacitor (803, 807, 811, 815,) having a top plate connected between each pair of diodes. The bottom plates of the capacitors alternately receive the non-overlapping clock signals CLK1 and CLK2. In this way, the output generates the level Vout from the input VCC. FIG. 8B illustrate the non-overlapping clock signals CLK1 and CLK2 having amplitude Vclock and period tosc. For regulating the charge pump, the output can be fed into a voltage divider, here formed of resistors R1 821 and R2 823, to provide a lower voltage (Vdiv) that can be compared to the reference value Vref by Amp 825 to generate the signal Control for regulating the pump, much as described above with respect to FIGS. 2 and 3.

Charge pump systems are often called upon to generate a large range of output voltages Vpp from the pump output. For example, in an application as a peripheral element on a flash EEPROM memory, Vout may need to range from 4 volts up to 28 volts for erasing or programming in operation. In order to cover this range, the number of stages used for the pump is based upon the highest voltage, in this example 28 volts. The regulation circuitry then varies the operation of the pump to provide the desired output level, as illustrated schematically in FIG. 8C.

In FIG. 8C the desired output Vout over the exemplary 4 volt to 28 volt range is plotted against the corresponding Control signal, here converted to a digital value ranging from 00 to FF in this example. The regulation can then be implemented by any of the standard, such as varying the clock frequency (1/tosc), clock amplitude (Vclock), pump input (VCC), etc.

While the pump may need to supply a few pulses near 28 volts, the majority of the Vout pulses are typically at a much lower voltage. Pump output impedance is a function of the number of stages. As output impedance increases, the pump is less efficient. For example, Vout operates at 4 volts with 10 stages is much less efficient than if operated at 4 volts with only 2 stages. Also, having more stages than needed for the lower voltage outputs results in a large amount of noise and higher power usage when operating at the lower voltage levels. Consequently, although a traditional charge pump needs to have enough stages to be able to provide the highest needed output value, when operating at lower values it will not as efficient as, and noisier than, a pump specific to the lower output.

To overcome these shortcoming, a charge pump system is described where the number of stages active in boosting the output voltage is automatically self-adaptive based on the desired output. The exemplary embodiment is based on a multi-stage implementation of the design of FIG. 4B. The number of stage is chosen is still based on the maximum output wanted from the design, but when regulated to provide lower output levels, the later stages progressively drop out, so that although the stages are still there, they no longer perform a pumping function and instead act as filtering stages to further reduce noise.

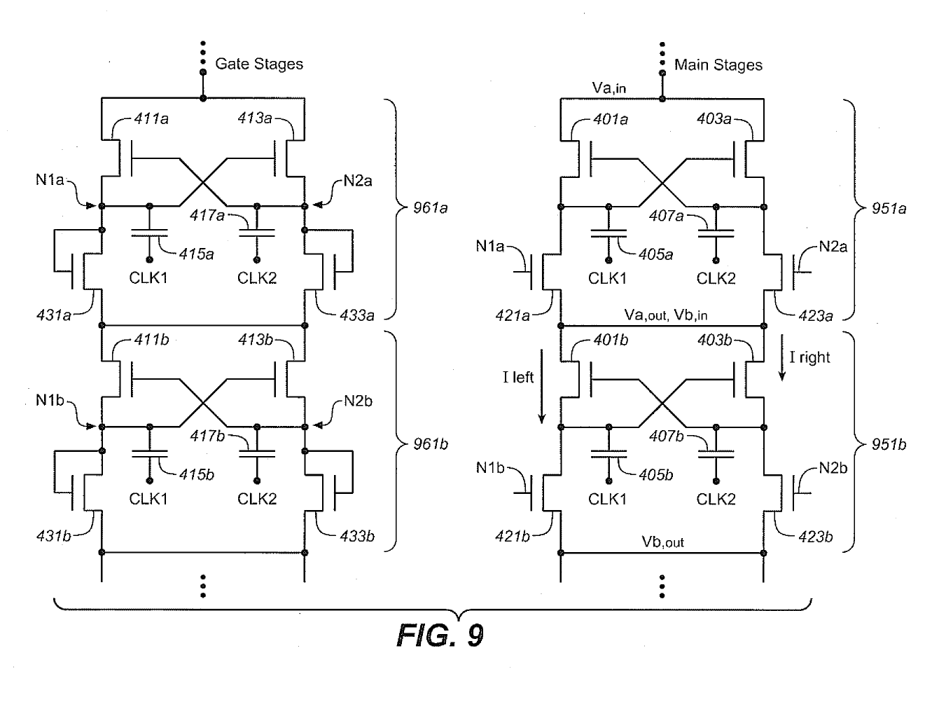

FIG. 9 illustrates an exemplary embodiment. As shown on the right side, a multiple number of main, or output, pump stages are connected in series, with the output of one stage in the series connected as input the next state. Only two of the stages, 951a and 951b, are explicitly shown to keep the figure manageable and each of the stages has the same structure as on the right hand side of FIG. 4A, but rearranged slight for convenience. (Basically, the placement of the capacitors and output nodes have been swapped between the representations.) For the first stage in the series will be the input voltage, such a Vcc, and the output of the last main stage in the series will be the output for the pump. As before, the legs of each main stage are connected to supply the stages output though a corresponding pair of switches controlled by a corresponding gate stage. Again, only two of the two or more gate stages are shown, with 961a and 961b corresponding to 951a and 951b. These gate stages are (again after some rearrangement) the same as shown on the left of FIG. 4A. For these gate stages, the output of one stage is supplied from the each of legs through a corresponding diode to provide the input of the next gate stage and the level on each leg (prior to the diode) controls the corresponding switch on the main, output stage side (the explicit connection is not shown to keep the e diagram manageable).

In more detail, looking the first stage 951a on the output side of FIG. 9, this shows a voltage double-type structure having a cross-coupled left and right legs that receive the input Va,in, that is either the input level of the pump (for the first stage) or the output of the previous stage (for all stages after the first). The left and right legs respectively have transistors 401a, 403a whose control gates are connected to other leg below these transistors. The gates of 401a, 403a are also respected connected to the top plates of the capacitors 405a, 407a, which in turn have there respective bottom plates driven by the non-overlapping clock signals CLK1, CLK2. The output of the two legs are then combined through the transistors 421a, 423a that are respectively controlled by the levels on the nodes N1a, N2a of the corresponding gate stage 961a to provide the output Va,out for stage 951a, which then acts as the input Vb,in for the next stage. In this way, the threshold voltage on the pass gates 421a, 423b is cancelled, as described above with respect FIGS. 4A and 4B and the subsequent discussion. The last stage in the series will then provide the output for the pump.

For the gate stages, each of these again has a cross-coupled structure similar to that of the corresponding main output stage, as is also discussed in more detail above. The gates stages are connected in series, with each stage's output supplying the next stage's input, except for first, which receives an initial input, and the last, which is only connected to control the pass gates of the last stage (much as shown on the left side of FIG. 4A). The legs of the gate stages in the series (excepting the last) are connected through a pass gate to provide the input to the next stage. In FIG. 9, the pass gates are implemented as the diode connected transistors 431a, 433a and 431b, 433b, although other implementations could use an additional Vt cancellation arrangement for some or all of these pass gates as well. It should be noted that for the gate stages the load is fixed, and that there is no DC current load, only a capacitive load from the pass gates (421, 423) on the main, output stage side.

In this way, higher output voltages can be generated in delivering power to the output, while still cancelling off the threshold voltages of the pass gates on the output side. An analysis of the arrangement of FIG. 9 also shows that it has another advantage, namely that at each stage the voltage is self-adapted to settle by the final output voltage being regulated into using the appropriate number of stages for the desired of output.

More specifically, if the output regulation is varying from, for example, 4 volts to 28 volts as shown, the number of stages, when all active, is selected to be able to provide the highest value of 28 volts; but, when regulated for lower output, the circuit of FIG. 9 will settle to the optimum number of pump stages, which will lead to the minimum charge pump output impedance. This is achieved in a self-adaptive manner, without the system needing to determine how many stages it wants to be active and generating as set of control signals to achieve this. This is distinct from the sort of prior art variable stage charge pump systems, such as those of U.S. Pat. Nos. 6,370,075 and 6,486,728, where control circuitry must determine the desired number of stages wanted to be active and then asserts a set of corresponding control signals to effect this.

To see how this occurs, consider the case where the circuit of FIG. 9 is being regulated to generate an output voltage less than its maximum. The input voltage will be raised progressively though the main stages until it reaches the desired level for the output, which, if this value is sufficiently below the maximum, will happen before the last stage. Consider the case where the output of stage 951a, Va,out, has reached this desired level. On the gate stage side, the nodes N1a and N2a of the corresponding gate stage 961a still operate to control pass gates 421a, 423a as described previously. However, as the gate stages only have no DC current load, only the capacitive load of the main stage pass gates, the subsequent gate stages (961b and any later gate stages) will continue to boost the levels (e.g., N1b, N2b) used on the pass gates (e.g., 421b, 423b) of the main stages down stream from 951a, such as 951b. This results in the pass gates 421b and 423b, as well as any subsequent ones, being left on. Because of this, main stage 951b and subsequent stages no longer are active to boost the output, but instead now act as filters of this output. When a higher output is again needed, 951b will self-adaptively revert back to a pumping function in the reverse manner.

This sort of transition of a pump stage, from being active as a pumping stage into performing a filtering function and back into pumping stage, described with respect to stage 951b will similarly in a self-adaptive way for the other stages of the pump, starting with the last of the main output stages in the series. As noted before, the number of stages for both the gate stages and main stages are selected to be able provide the highest needed output. To take an example, say the pump needs to provide an output voltage over the 4V-28V range again and that to produce the 28 volt level uses six stages. When 28V are needed, all six stages are active pumping, but if the output drops to below, say, 25V, this can be reached with only five stages and the last will transition as described for stage 951b. Similarly, when the desired output drops 20V or less, the fifth stage would switch from actively pumping and both the last two stages would act as a filter capacitance, and so one until at the lowest output levels, only the first one or two stages are active in boosting, with the rest acting as a filtering capacitance. When the output is regulated back up, the stages will kick back into the pumping mode in this self-adaptive manner.

Consequently, as the output regulation is varied from 4V to 28V (or whatever the range is), the circuit will settle to the optimum number of pump stages, leading to a minimum charge pump output impendence. Under this arrangement, the pump impedance is self-adaptive to the output setting. There will consequently be less output noise due to the bypassed stages which also transition to a filtering capacitance. Such a minimizing of charge output impedance will lead can help to optimize the charge pump's performance. Consequently, in addition to the Vt cancelation for the transfer gates of the high voltage charge pump, this provides a simple scheme that is self adaptive to achieve the minimum output impedance and minimize output ripple, all without the need for some sort of control circuitry to somehow determine the desired number of stages and actively implement this somehow.

Concerning regulation, any of the various regulation schemes, such as those described above or in the various references cited above, can be applied to the design here. For example, the output voltage from the main stage could be sampled and the Control signal can either be a logically value or an analog value. The Control signal can be used to, say, control the input voltage supply level, the clock frequency, clock amplitude and so on to maintain the regulation level. (In this clock cases, the regulation control signal, such as Control in FIG. 8A, would need to be used to alter the generation of the clock signals supplied to the pump, a sort of connection not explicitly represented in FIG. 2.) The regulation of the gate stages can be done similarly to the output stages, or done independently with a separate regulator. It the gate stages are using the same regulation as the main stages, it may be desirable to have its output at the various stage to offset relative to the main stage output, using a diode for example.

### Regulation Based Multi-Stage Implementation

As discussed in the last section, pump performance can be improved by having the appropriate number of stages for desired output. For the embodiments presented in this section, the number of stages that are active in boosting is determined by the regulation circuitry, rather than then according to the self-adaptive mechanism of the previous section.

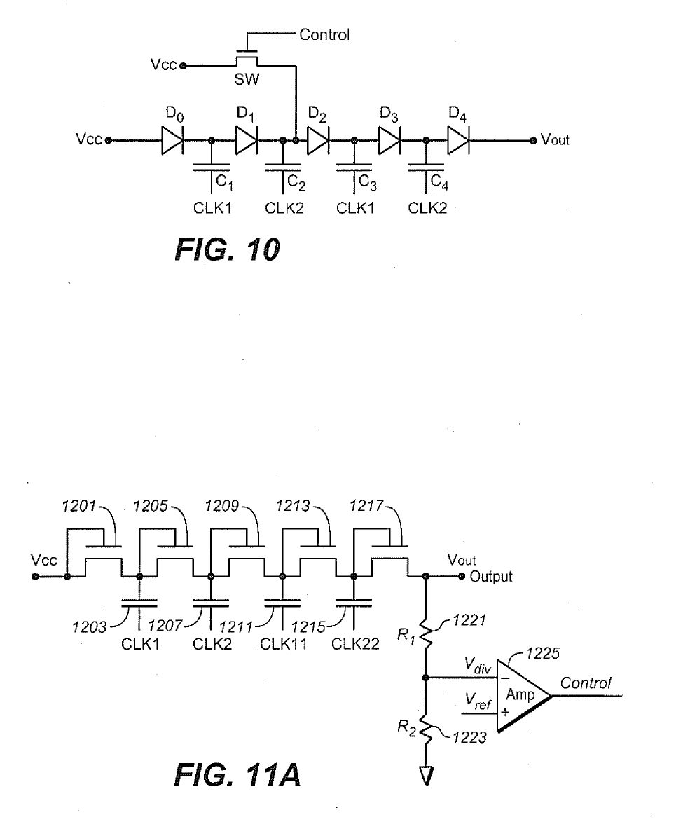

As noted in the last section, prior art arrangements, such as those of U.S. Pat. Nos. 6,370,075 and 6,486,728, describe a variable stage charge pump system where the number of active stages are effected using a set of corresponding control signals. FIG. 10 schematically illustrates this sort of arrangement for the example of a four stage Dickson-type charge pump operable in either a two stage mode or a four stage mode. As shown in FIG. 10, a series of diodes (D₀, D₁, D₂, D₃, D₄) are connected series with one plate of each stage's capacitor (C₁, C₂, C₃, C₄) connected to a node between each pair of diodes. The other plates of the capacitors are alternately to either CLK1 or CLK2. So far, this is the same arrangement as with the pump of FIG. 8A of a four stage pump. To allow selective two stage operation for when less boosting is wanted, the switch SW is introduced, allowing the first two stages to be bypassed. In response to a control signal, the input voltage Vcc is instead applied at the first terminal of D₂ instead of that of D₀. For the first two stage, these could be disconnected from the input of D2, shut off, or both, when the control signal is asserted, although these are not explicitly shown. Consequently, the input level is boosted though either two or four stage hooked in series based on the control signal from the regulation circuitry.

The embodiment of this section also presents a multi-stage charge pump where some of the stages can be removed from the boosting process, but differs in several important respects. One of the more readily apparent one of these is that the prior art removes pump stages at the start of the series, whereas the exemplary embodiment preferable remove stages at the end. The bigger difference is in how they are removed—or, more accurately, in that they are not removed at all, but left connected in series and the clock signal changed for them. This converts then converts these last stages from a boosting mode into filters to smooth the output. Consequently, in this arrangement, having the stages switched from boosting be from the last few stages allows them to filter the preceding stages. Also, switching the initial stages would also be less effective and as there has not yet been any boosting and some voltage will be lost across the stages in a filtering mode. Note that this can also be considered to be a somewhat counterintuitive thing to do since these last stages, when in filter mode, would drop the voltage of the output some, when the function of the pump is to boost the voltage.

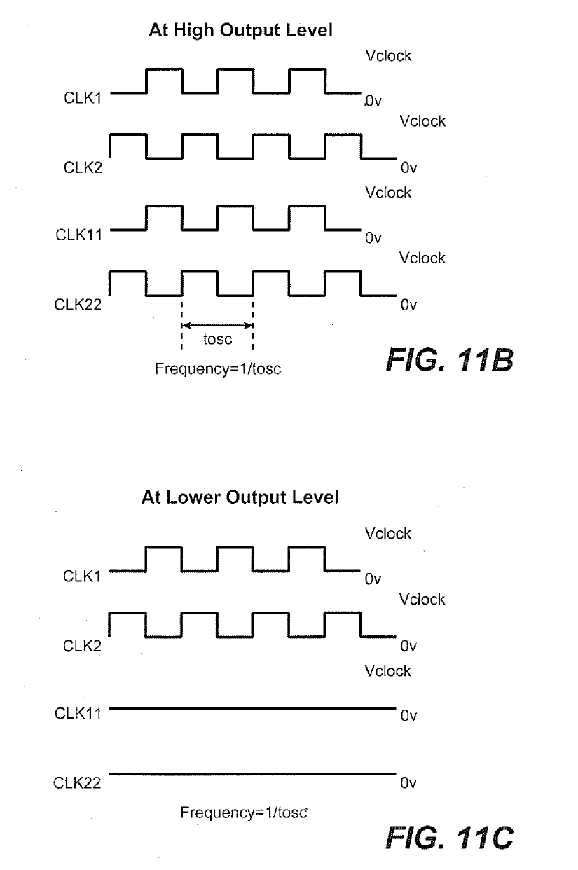

In this section, the exemplary embodiment is again based on a Dickson-type pump, as this readily compares with FIGS. 8A and 10, and will again be presented in FIGS. 11A-C for a four stage embodiment. In FIG. 11A, the pump is again arranged as in FIG. 8A with corresponding numbers used for corresponding elements. The capacitors 1203 and 1207 of the first two stages again receive the respect clock signals CLK1 and CLK2. Rather those capacitors 1211 and 1215 of the last two stages respectively receiving CLK1 and CLK2, however, they now receive the clock signals CLK11 and CLK22.

When the pump is operating in the 4-stage mode, all the stages receive a non-trivial clock signal and CLK11 and CLK22 are respectively the same as CLK1 and CLK2, as shown in FIG. 11B; that is, in the higher output, four-stage mode, the pump is running the same as in FIGS. 8A and 8B with all four stages function as boosting elements. For lower output levels, however, the clocks CLK11 and CLK22 are set to ground, as shown in FIG. 11C. Because of this, the last two stages no longer have a boosting function, but instead act as filter elements. There can also be an intermediate output, 3-stage mode where only the last stage's clock is set to ground. With or without an intermediate mode, based on the Control signal from the regulation circuitry, the number of pump stages active in boosting the output is reduced as the regulation goes lower. When there are one or more intermediate modes, the number of pump stages can be gradually lowered in steps. This will improve power consumption and noise at lower regulated output levels.

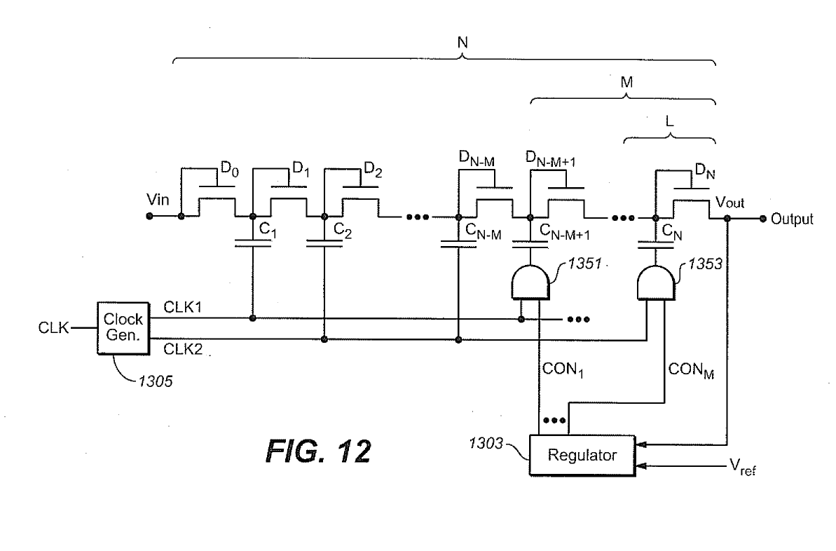

FIG. 12 is a schematic representation of a more general embodiment for a Dickson-type pump. Here the pump has N stages, with diode connected transistors D₀-D_{N} connected in series to receive the input voltage at the first and provide the output from the last. The capacitors C₁-C_{N} then have one plate between a pair of diodes and the other plate to receive one of the clock signals. The regulation circuitry 1303 is connected to receive both the output Vout from pump and a reference level Vref and, based on these, determines the control signal (or signals). The last M stages (stages (N−M+1) to N) are then operable in either the boosting mode or the filtering mode, based on the clock signals they receive. (In the example, N and M are even integers, but this need not be the case.) The number of the M stages that are being operated in the filtering mode is then L, where, depending on the embodiment, L can be any or all of the values from 0 to M. (In FIG. 12, L is indicated as at least 1, but more generally may be any value from 0 to M.) The switching of these last M stages between a boosting and a filtering function can be done individually or pairs or other groups, even up to all M at once, depending on the implementation, as the regulation level is raised or lowered. Generally speaking, finer granularity gives better performance but requires finer control. The total number of stages, N, is based on the maximum expected needs of the system and the lowest number of stages, (N−M), on the lowest expected output requirement.

The switching of pump modes, where the clocks can be implemented in a number ways. In the example of FIG. 12, the clock generation circuit takes in a base clock signal CLK and generates from this the pair of non-overlapping clock signals CLK1 and CLK2, which are alternately supplied to the stages. The ability to set the last M stages' clocks individually or multiply to ground based on the control signal can be effected in a number of ways by clock circuitry 1305. Here, this is done schematically by a set of M AND gates, 1351-1353, that alternately receive CLK1 and CLK2 at one input and one of the set of control signals COM-CON_{M} at the other, so that as these control signals are asserted/de-asserted the corresponding stage functions in a boosting/filtering mode.

It should again be noted that the non-boosting stages are not bypassed, by still in the series acting as a filter. Consequently, power will be saved by only having the number of stages required to generate the desired output active. This will also lead to less noise at lower output levels, even before the added filtering of the non-boosting stages further reduces any ripple. Although the preferred embodiment places these switchable stages at the end, more generally they could be placed elsewhere in the series; but by placing them last, the filtering is most effective and, since there will be some loss across the filter, it is preferred to have all the boosting before the filtering. Consequently, if less than all of the switchable stages are in filtering mode, these will be taken from the end of the series. So that as the regulation level is lowered, the stages that are filtering will be successive added so that the are the last set of stages, being switched back to boosting in the reverse order as the regulation level goes back up.

The preferred embodiments use the arrangement where the L stages operating in the filtering mode are the last L stages for the reasons described. However, other embodiments may be arranged differently, with the L filtering stages not being the last ones in the series. This could be done due to, say, layout or other practical considerations. For example, since a typical arrangement is based on two non-overlapping clocks being used for the pumping stages, it may be easier to start by selectively switching stages using just one of these clocks to the filtering mode first (e.g., alternate stages starting with stage N, then stage (N−2) when a second stage is transitioned and so on). Similarly, in more general embodiments, the M stages operable either in the boosting mode or the filter mode need not be the last M stages.

The exemplary embodiment presented in this section is based on a Dickson-type pump, but the concept is applicable to other types of charge pump systems, although the particulars of the charge pump design need to be considered. For example, the ideas presented here could also be used for a multistage pump using a voltage doubler type of structure, such as those in FIG. 9 or FIG. 4A. Since each stage of a voltage doubler receives a pair of clock signals, in order to transition a stage to a filtering function, both of the clocks to a given stage would be taken to ground. And although this section described a regulation scheme based only on varying the number of stages, this can be combined with other regulatory schemes (varying clock frequency, clock amplitude, input voltage, etc.) described in the preceding sections and in the various references cited above.

Although the invention has been described with reference to particular embodiments, the description is only an example of the invention's application and should not be taken as a limitation. Consequently, various adaptations and combinations of features of the embodiments disclosed are within the scope of the invention as encompassed by the following claims.

It is claimed:

1. A charge pump system circuit to generate an output voltage, including:
a plurality N of charge pump stages, each receiving one of a plurality of clock signals, the stages connected in series with an input of the first stage in the series connected to receive an input voltage, an output of each of the stages except the last in the series connected to provide an input for the next stage, and an output of the last in the series providing the output voltage;
regulation circuitry connected to receive a reference voltage and the output voltage and derive therefrom a control signal; and
clock circuitry connected to receive the control signal and to provide the plurality of clock signals to the pump stages, where, in response to the control signal the charge pump system operates in one of a plurality modes, including: a first mode, where all of stages receive non-trivial clock signals; and a second mode, where L stages of the series have their clock signals set to ground and the other stages of the series receive non-trivial clock signals, wherein L is greater than zero and less than N.

2. The charge pump system circuit of claim 1, wherein the L stages of the series that have their clock signals set to ground are the last L stages of the series.

3. The charge pump system circuit of claim 1, wherein the modes include a plurality of M second modes, wherein M is greater than zero and less than N, and each of the M second modes a corresponds to L having a value of from 1 to M.

4. The charge pump system circuit of claim 1, wherein each stage includes a corresponding capacitor each receiving the stage's clock signal at a first plate of the stage's capacitor.

5. The charge pump system of claim 4, wherein each stage further includes a diode, each diode having a first terminal connected to receive the input of the stage and second terminal connected to provide the output of the stage, and wherein the a second plate of the stage's capacitor is connected to the first terminal of the stage's diode.

6. The charge pump system of claim 5, wherein the diodes are implemented as diode connected transistors.

7. The charge pump system circuit of claim 1, the clock signals include first and second non-overlapping clock signals, the first (N−L) stages alternately receiving the first and second non-overlapping clock signals.

8. The charge pump system circuit of claim 1, wherein the clock circuitry receives an input clock signal and generates the plurality of clock signals therefrom.

9. A charge pump system, including:
a plurality N of charge pump stages connected in series to receive an input voltage at the first stage and to generate therefrom an output voltage provided from the last stage, where M of the N stages are operable in either of a boosting mode or a filtering mode, wherein M is greater than zero and less then N, and where, in response to a control signal, L of the M stages operable in either of a boosting mode or a filtering mode are operated in the filtering mode and the other (N−L) stages are operated in the boosting mode, where L is greater than or equal to zero and less than or equal to M; and
regulation circuitry connected to receive the output voltage and a reference voltage and determine therefrom the control signal.

10. The charge pump system of claim 9, where said M stages are the last M of the N stages.

11. The charge pump system of claim 10, where said L stages are the last L of the M stages.

12. The charge pump system of claim 9, wherein each of the charge pump stages comprises a capacitor connected to receive a corresponding clock signal where, in response to the control signal, the clock signals of the last stages are set to ground.

13. The charge pump system of claim 9, wherein the charge pump stages have Dickson-type charge pump structure.

14. A method of operating a multi-stage charge pump of N stages connected in series and having an input and an output, including:
receiving an input voltage at the input of the charge pump;
generating in the charge pump an output voltage from the input voltage;
receiving the output voltage at a regulator circuit;
receiving a reference level at the regulator circuit;
generating by the regulator circuit of a control signal based on the output voltage and the reference level; and
in response to the control signal, operating L of the N stages as filtering stages and the other (N−L) stages are boosting stages, where L is a non-negative integer less than N and where the value of L is determined based on the value of the control signal

15. The method of claim 14, wherein the L stages operating as filtering stages are the last L stages of the series of N stages.

16. The method of claim 14, wherein the charge pump has a Dickson-type pump structure.

17. The method of claim 14, further comprising:
providing each of the stages with one of a plurality of clock signals, wherein the last L stages receive a clock signal set to ground in response to the control signals.

18. The method of claim 17, where the first (N−L) each receive one of a pair of non-overlapping clock signals.
